(19) United States
(12) Patent Application Publication
(10) Pub. No.: US 2011/0047751 A1
(43) Pub. Date: Mar. 3, 2011

(54) HINGE AND AN ELECTRONIC DEVICE WITH THE SAME

(76) Inventor: Chia-Hsiang CHEN, Shulin City (TW)

(21) Appl. No.: 12/553,979

(22) Filed: Sep. 3, 2009

(51) Int. Cl. E05F 1/08; E05D 3/06; G06F 1/16

(52) U.S. Cl. 16/303; 16/366; 361/679.55

(57) ABSTRACT

A hinge has a first pivoting module having a connecting block with a bore, a first pivot shaft and a second pivot shaft mounted on two opposite sides of the connecting block, a first movable assembly mounted on one end of the first pivot shaft and having a first urged piece and a first movable piece tracing and urging against the first urged piece to drive the first pivot shaft to radially move, a second movable assembly mounted on one end of the second pivot shaft to operate in coordination with the first movable assembly and having a second urged piece and a second movable piece tracing and urging against the second urged piece to drive the second pivot shaft to radially move; and a second pivoting module pivotally mounted on the connecting block. Such hinge addresses opening smoothness of the top lid of electronic device and aesthetic allure.

### BACKGROUND OF THE INVENTION

1. Field of the Invention

The present invention is related to a hinge and an electronic device with the same, and more particularly to a hinge enabling a pivot shaft thereof to move while pivoting and electronic devices using the hinge to smoothly operate without obstruction.

2. Description of the Related Art

With reference to FIGS. 13 and 14, a conventional portable electronic device, such as a mobile phone or notebook computer, has a base (90, 90A), a hinge (91, 91A) and a top lid (92, 92A). The hinge (91, 91A) is pivotally connected with the base (90, 90A) and the top lid (92, 92A) so that the top lid (92, 92A) can be pivoted with respect to the base (90, 90A). A cover (93, 93A) is mounted on the base (90, 90A) to enclose the hinge (90, 90A).

When users open the top lid (92, 92A), a neighboring portion of the cover (93, 93A) impedes the movement of the top lid (92, 92A), preventing the top lid (92, 92A) from being fully opened. To tackle the issue, modification of the cover (93, 93A) could be one of the solutions.

With reference to FIG. 13, a skew surface (94) is formed on an edge of the cover (93) abutting the top lid (92). Thus, when the top lid (92) is pivoted with respect to the hinge (91), the top lid (92) can be fully opened without interfering with the cover (93). However, such skew surface (94) adopted by the cover (93) makes the conventional electronic device lack a streamline contour, imposes limitation on the contour of the conventional electronic device and further reduces purchasing desirability of customers.

With reference to FIG. 14, other technical means are also addressed to solve the issue. A space is formed between the top lid (92A) and the cover (93A) so as to further increase the rotation radius of a side in the proximity of the top lid (92A) with respect to the hinge (91A). As a result, when lifting up the top lid (92A), the top lid (92A) can avoid a neighboring side, thereby improving the interference issue upon lifting up the top lid. However, adding the space between the top lid (92A) and the cover (93A) also increases the overall length of the electronic device. Such solution not only runs counter to design requirements and trends tending toward compact and lightweight devices, but also impacts on the aesthetical appeal of the conventional electronic devices, thereby lowering the purchasing desirability. Consequently, the foregoing two solutions are ineffective and fail to meet market demands.

### SUMMARY OF THE INVENTION

An objective of the present invention is to provide a hinge and an electronic device having the hinge. Given the hinge and the electronic device having the hinge of the present invention, the shortcoming that conventional hinges fail to provide smooth opening at both ends of the top lid of electronic devices coupled with aesthetic allure.

To achieve the foregoing object, the hinge of the present invention has a first pivoting module and a second pivoting module.

The first pivoting module has a base, a first pivot shaft, a second pivot shaft, a first movable assembly and a second movable assembly. The connecting block has a bore. The first pivot shaft and the second pivot shaft are mounted on two opposite sides of the connecting block. The first movable assembly is mounted on one end of the first pivot shaft and has a first urged piece and a first movable piece pivoting tracing and urging against the first urged piece so as to drive the first pivot shaft to radially move. The second movable assembly is mounted on one end of the second pivot shaft to operate in coordination with the first movable assembly and has a second urged piece and a second movable piece pivoting tracing and urging against the second urged piece so as to drive the second pivot shaft to radially move.

The second pivoting module is pivotally mounted on the connecting block.

To achieve the foregoing objective, the electronic device having the hinge of the present invention has a base, a top lid, a hinge and a cover. The top lid has a display screen. The hinge is connected with the base and the top lid. The cover is mounted on the base to enclose the hinge.

The hinge has a first pivoting module and a second pivoting module. The first pivoting module has a connecting block, a first pivot shaft, a second pivot shaft, a first movable assembly and a second movable assembly.

The first pivoting module is connected with the base. The connecting block has a bore. The first pivot shaft and the second pivot shaft are mounted on two opposite surfaces of the connecting block. The first movable assembly is mounted on the first pivot shaft and has a first urged piece and a first movable piece tracing and urging against the first urged piece to radially move the first pivot shaft.

The second movable assembly is mounted on the second pivot shaft to operate in coordination with the first movable assembly and has a second urged piece and a second movable piece tracing and urging against the second urged piece so as to radially move the second pivot shaft.

The second pivoting module pivotally is mounted on the connecting block and connected with the top lid.

According to the aforementioned description, the electronic device having the hinge of the present invention obviates the prior art issue of the cover conflicting with the top lid while opening the top lid. Upon lifting up the top lid, the first and second pivot shafts are driven to pivot so that the second movable piece traces and urges against the second urged piece. Meanwhile, the first movable piece also traces and urges against the first urged piece. Therefore, the first movable piece and the second movable piece can make the connecting block drive the second pivoting module and the top lid to move, thereby avoiding the cover. Further, the electronic device is light and compact yet provides a top lid that can be smoothly opened without conflicting with the cover. Therefore purchasing desirability of customers is also promoted accordingly.

### BRIEF DESCRIPTION OF THE DRAWINGS

FIG. 1 is a perspective view of a first preferred embodiment of a hinge in accordance with the present invention;

FIG. 2 is a perspective view of a second preferred embodiment of the hinge in accordance with the present invention;

FIG. 3 is a perspective view of a third preferred embodiment of the hinge in accordance with the present invention;

FIG. 4 is an exploded view of the hinge in FIG. 1;

FIG. 5 is an exploded view of the hinge in FIG. 2;

FIG. 6 is an exploded view of the hinge in FIG. 3

FIGS. 7A to 7C show partial side views of the hinge in FIG. 1 when the hinge is opening;

FIGS. 8A to 8C show partial side views of the hinge in FIG. 2 when the hinge is opening;

FIGS. 9A to 9C show partial side views of the hinge in FIG. 3 when the hinge is opening;

FIG. 10 is a perspective assembly view of a preferred embodiment of an electronic device having a hinge in accordance with the present invention;

FIG. 11 is a side view of the electronic device having the hinge in FIG. 10 when the electronic device is closed;

FIG. 12 is a side view of the electronic device having the hinge in FIG. 10 when a top lid of the electronic device is lifted;

FIG. 13 is a side view of a conventional electronic device in accordance with the prior art; and

FIG. 14 is a side view of another conventional electronic device in accordance with the prior art.

### DETAILED DESCRIPTION OF THE INVENTION

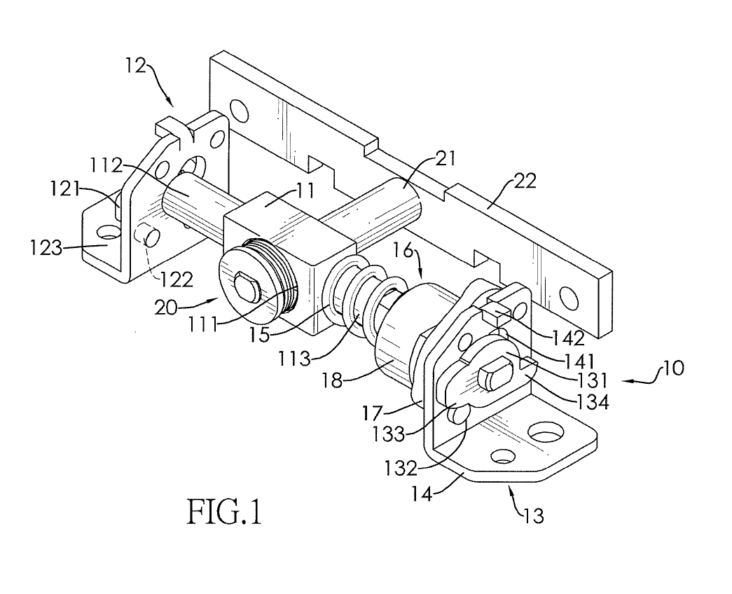

With reference to FIGS. 1 to 3, a hinge in accordance with the present invention has a first pivoting module (10) and a second pivoting module (20).

The first pivoting module (10) comprises a connecting block (11), a first pivot shaft (112), a second pivot shaft (113), a first movable assembly (12) and a second movable assembly (13). The connecting block (11) has a bore (111) formed therein. The first pivot shaft (112) and the second pivot shaft (113) are mounted on two opposite sides of the connecting block (11). The first movable assembly (12) is mounted on the first pivot shaft (112). The second movable assembly (13) is mounted on the second pivot shaft (113). The first movable assembly (12) has a first movable piece (121) and an urged piece (122). The first movable piece (121) is fixedly mounted on the first pivot shaft (112) and is driven by the first pivot shaft (112) to trace and urge against the first urged piece (122) so that unequal movement is generated by the first movable piece (121) and the first pivot shaft (112). The second movable assembly (13) has a second movable piece (131) and a second urged piece (132). The second movable piece (131) is fixedly mounted on the second pivot shaft (113) and is driven by the second pivot shaft (113) to trace and urge against the second urged piece (132) so that unequal movement is generated by the second movable piece (131) and the second pivot shaft (113) while equal movement is generated by the first and second movable assembly (12, 13). Therefore, the connecting block (11) and the first and second pivot shafts (112, 113) can firmly move.

The second pivoting module (20) is pivotally mounted on the connecting block (11) and has a pivot shaft (21). One end of the pivot shaft (21) can be pivotally mounted in the bore (111) of the connecting block (11). A connection frame (22) is mounted on the other end of the pivot shaft (21).

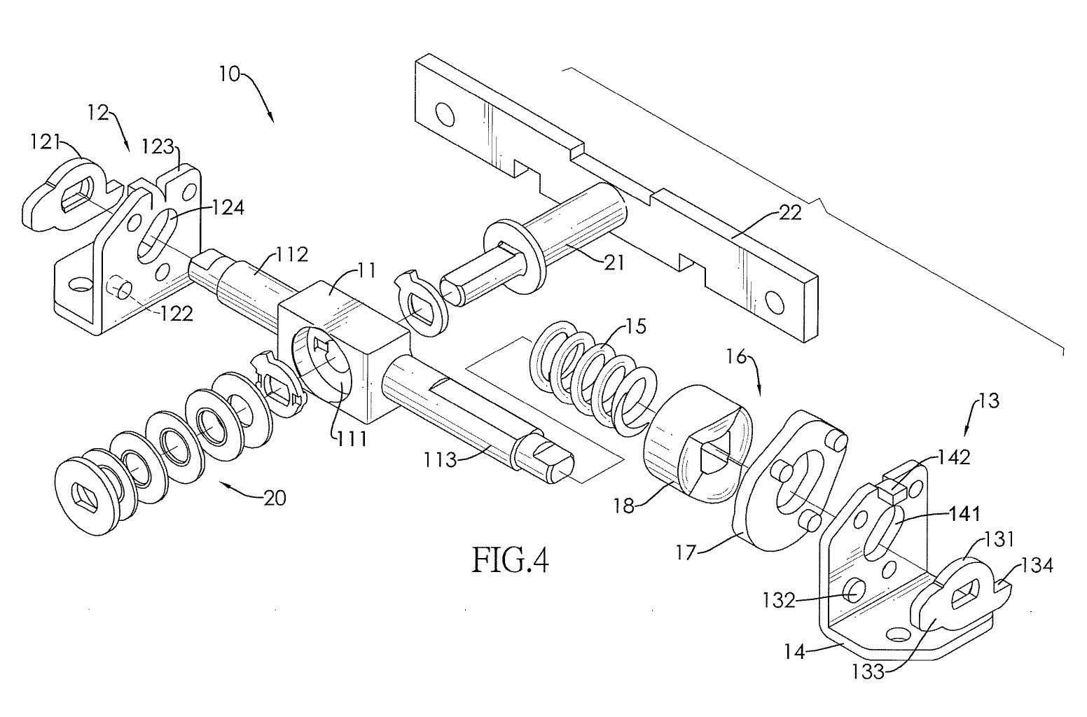

With reference to FIGS. 1 and 4, which show the first embodiment of the present invention, the second movable assembly (13) has a second support seat (14), a torsion spring (15) and a positioning cam assembly (16). The second support seat (14) is L-shaped and has an upright wing and a lateral wing. An elongated hole (141) is formed on the upright wing for the second pivot shaft (113) to insert movably. The second urged piece (132) is fixedly mounted on the upright wing of the second support seat (14). A stopper (142) is mounted on a top edge of the upright wing and extended outwardly in a perpendicular direction to the upright direction. One side of the torsion spring (15) abuts the connecting block (11) and the other end of the torsion spring (15) abuts the positioning cam assembly (16). The positioning cam assembly (16) is mounted between the torsion spring (15) and the second support seat (14). The second movable piece (131) is mounted securely around an end portion of the second pivot shaft (113). The second movable piece (131) has an urging portion (133) and a limiting portion (134) limited and positioned by the stopper (142).

The positioning cam assembly (16) has a fixed cam (17) fixed on the second support seat (14) and a pivoting cam (18) driven by the second pivot shaft (113) to pivot. A surface of the fixed cam (17) and a neighboring surface of the pivoting cam (18) correspond to each other. The first movable assembly (12) has a first support seat (123) mounted symmetrically to the second support seat (14). A mounting hole (124) is formed on the first support seat (123) to correspond to the elongated hole (141) so that the first pivot shaft (112) can be inserted and move in the mounting hole (124). The first urged piece (122) is fixedly mounted on an outside surface of the first support seat (123). The first movable piece (121) is fixedly mounted on an end portion of the first pivot shaft (112).

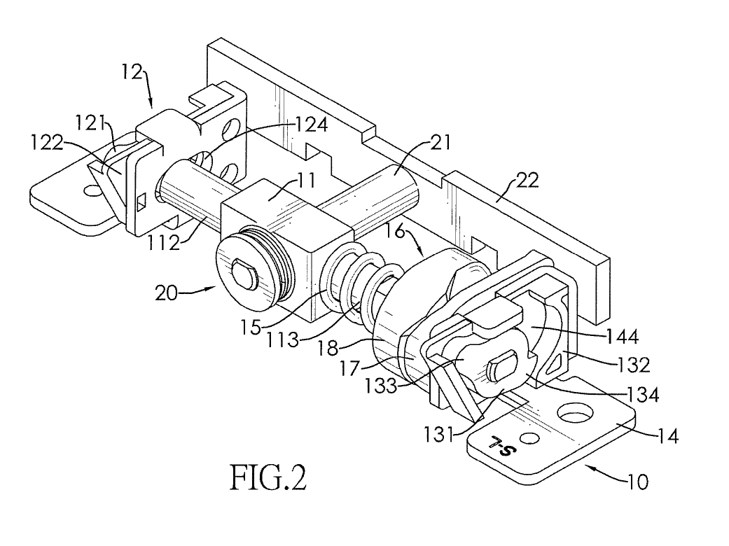

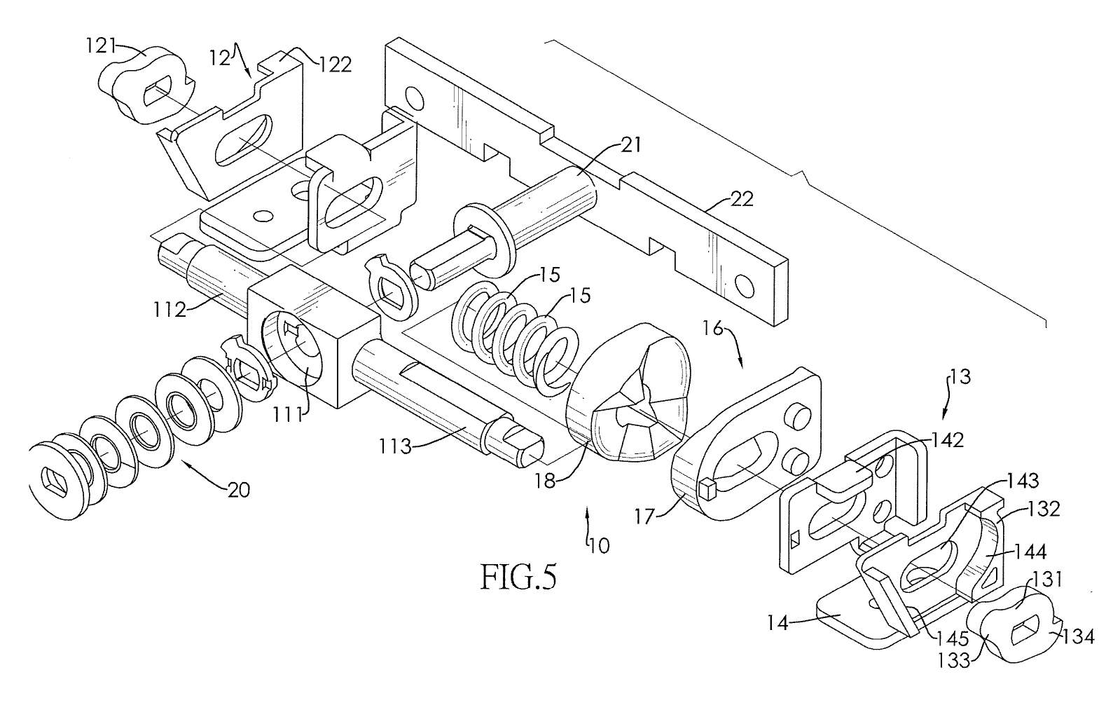

With reference to FIGS. 2 and 5, which shows the second embodiment of the present invention, the second embodiment differs from the first embodiment in that a sunken space (144) is formed on one side of a second urged piece (132) to receive the second movable piece (131). A sloped surface (145) is formed on the same side of the second urged piece (132) to urge against the urging portion (133), thereby similarly attaining the desired movement.

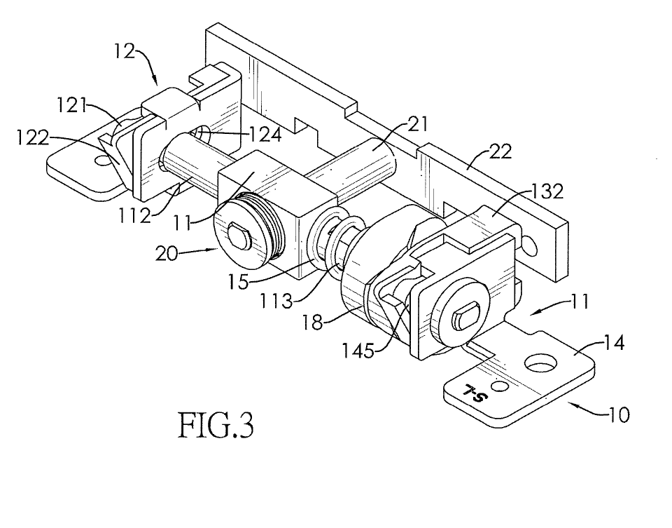

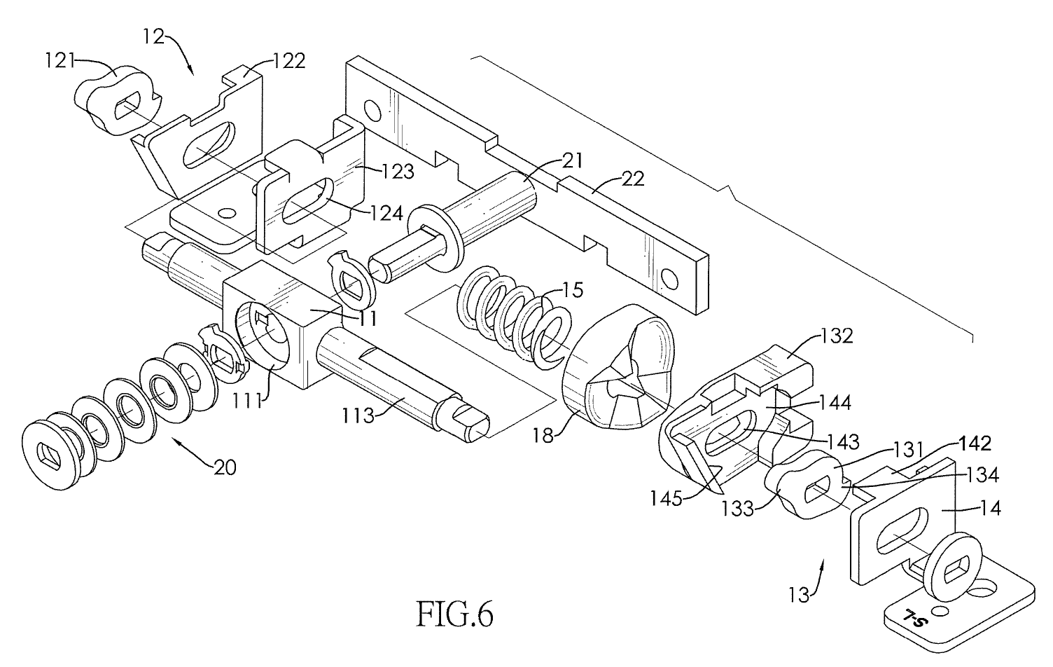

With reference to FIGS. 3 and 6, which show the third embodiment, the third embodiment differs from the first and second embodiments in that the second urged piece (132) is mounted securely around the second support seat (14) and is mounted between the pivoting cam (18) and the second support seat (14). One side of the second urged piece (132) is corresponds with one side of the pivoting cam (18). A sunken space is formed on an opposite side of the second urged piece (132) to receive the second movable piece (131). A sloped surface (145) is formed on the second urged piece (132). The second movable piece (131) has an urging portion (133) moving along and urging against the sloped surface (145) to drive the second pivot shaft (113) and the connecting block (11) to displace, and a limiting portion (134) limited by the stopper (142).

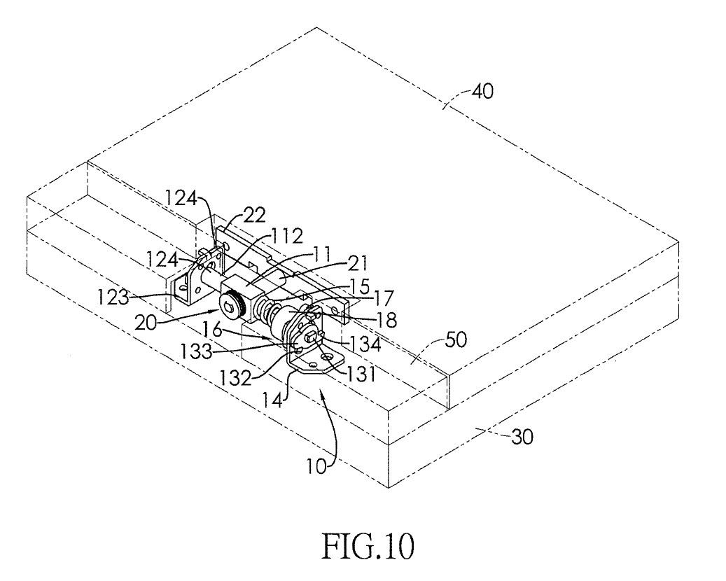

The foregoing hinges can be adopted in electronic devices such as notebook computers, mobile phones or the like. With reference to FIG. 10, an electronic device in accordance with the present invention has a base (30), a top lid (40) having a screen and the hinge connected with the base (30) and the top lid (40). A cover (50) is mounted on the base (30) to enclose the hinge. The first pivoting module (10) of the hinge is mounted on the base (30). The second pivoting module (20) is pivotally connected with the connecting block (11) and is connected with the top lid (40) by using the connection frame (22).

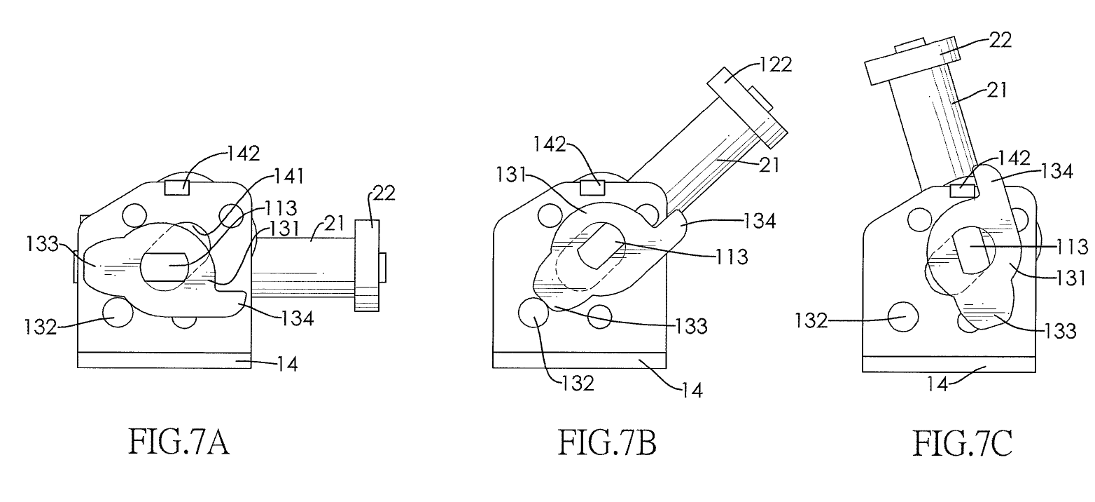

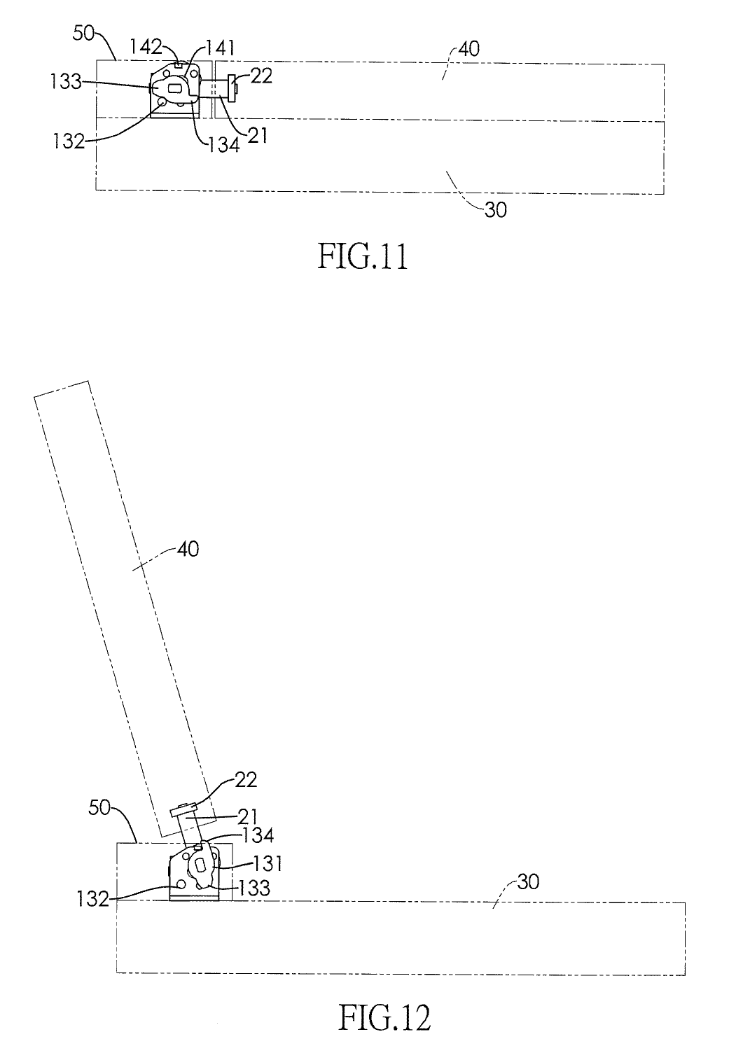

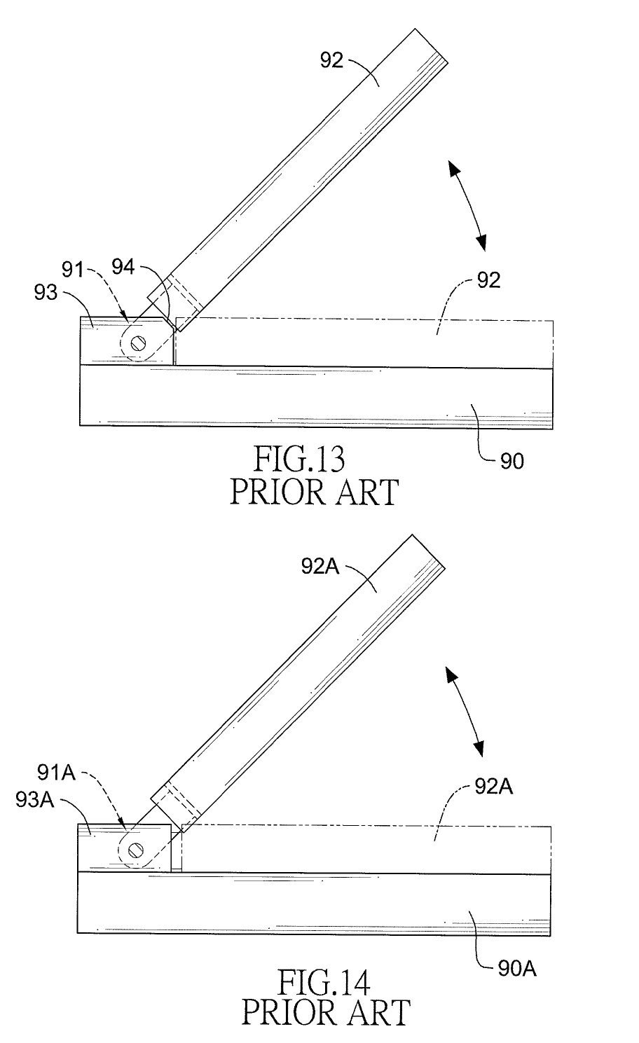

With reference to FIGS. 7A, 7B, 7C, 11 and 12, when the top lid (40) is opened relative to the base (30), the connecting block (11), the first pivot shaft (112), the second pivot shaft (113), the first movable piece (121) and the second movable piece (131) are driven to move. The urging portion (133) of the second movable piece (131) moves along and urges against the second urged piece (132) so as to radially move the second pivot shaft (113) outwardly. Likewise, the first movable piece (121) also moves along and urges against the first urged piece (122) so as to radially move the first pivot shaft (112) outwardly, thereby avoiding the obstruction of the cover (50). Once pivoted to an adequate angle, the limiting portion (134) is stopped by the stopper (142) to limit pivoting movement within a predetermined range.

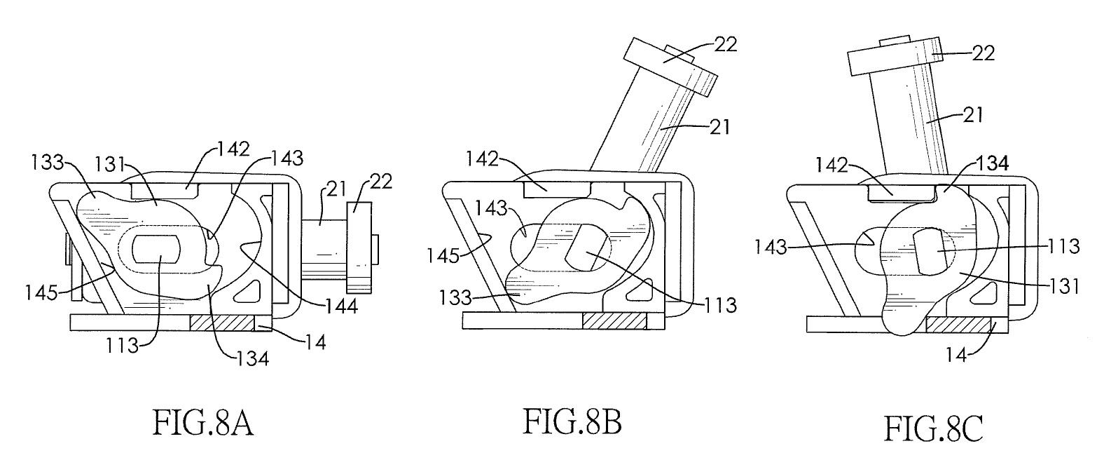

With reference to FIGS. 8A, 8B, 8C, 11 and 12, when the top lid (40) is opened relative to the base (30), the connecting block (11), the first pivot shaft (112), the second pivot shaft (113), the first movable piece (121) and the second movable piece (131) are driven to move. The urging portion (133) of the second movable piece (131) moves along and urges against the sloped surface (145) of the second urged piece (132) so as to radially move the second pivot shaft (113) outwardly. Likewise, the first movable piece (121) also moves along and urges against the first urged piece (122) so as to radially move the first pivot shaft (112) outwardly, thereby avoiding the obstruction of the cover (50). When pivoted to an adequate angle, the limiting portion (134) is stopped by the stopper (142) to limit pivoting movement within a predetermined range.

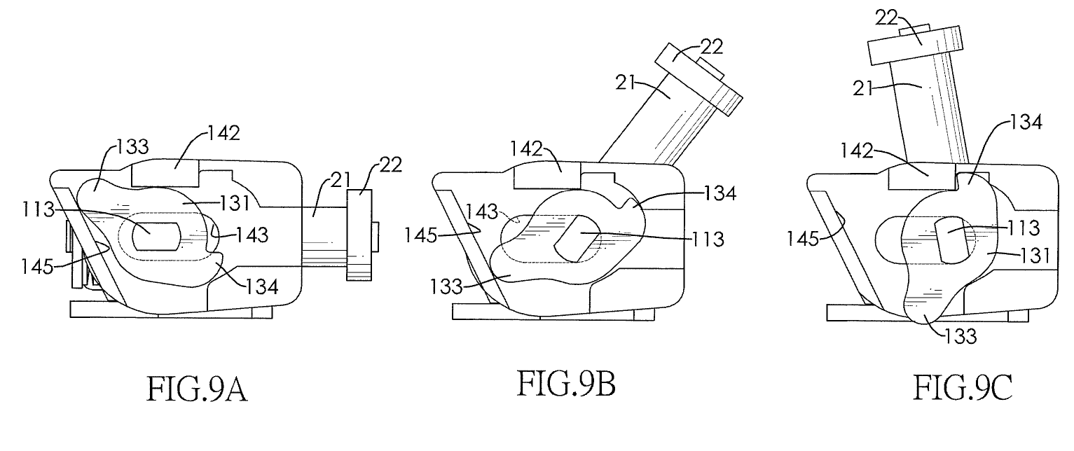

With reference to FIGS. 9A, 9B, 9C, 11 and 12, when the top lid (40) is lifted, the connecting block (11), the first pivot shaft (112), the second pivot shaft (113), the first movable piece (121) and the second movable piece (131) are driven to move. The urging portion (133) of the second movable piece (131) moves along and urges against the sloped surface (145) of the second urged piece (132) so as to radially move the second pivot shaft (113) outwardly. Likewise, the first movable piece (121) also moves along and urges against the first urged piece (122) so as to radially move the first pivot shaft (112) outwardly, thereby avoiding the obstruction of the cover (50). Once pivoted to an adequate angle, the limiting portion (134) is stopped by the stopper (142) to limit pivoting movement within a predetermined range.

In sum, the hinge of the present invention enables the top lid (40) of the electronic devices equipped with the hinge to move to the adequate angle to avoid the obstruction of the cover (50) while lifting the top lid (40), so as to smoothly open and close the top lid (40). Without changing the contour of the cover (50) and increasing the space between the top lid (40) and the cover (50), the contour of the electronic device can still be designed compact and light weight, the top lid can smoothly open and close and purchasing desirability of customers is thereby promoted.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A hinge, comprising:
a first pivoting module having a connecting block with a bore, a first pivot shaft and a second pivot shaft mounted on two opposite sides of the connecting block, a first movable assembly mounted on one end of the first pivot shaft and having a first urged piece and a first movable piece tracing and urging against the first urged piece so as to drive the first pivot shaft to radially move, a second movable assembly mounted on one end of the second pivot shaft to operate in coordination with the first movable assembly and having a second urged piece and a second movable piece tracing and urging against the second urged piece so as to drive the second pivot shaft to radially move; and
a second pivoting module pivotally mounted on the connecting block.

2. The hinge as claimed in claim 1, wherein the second movable assembly further comprises a second support seat, a torsion spring and a positioning cam assembly, an elongated hole is formed on the second support seat for the second pivot shaft to insert and move therein, the second urged piece is fixedly mounted on the second support seat, a stopper is mounted on the second support seat, the stopper, the elongated hole and the second urged piece are located on a same side of the second support seat, the second movable piece is fixedly mounted on the other end of the second pivot shaft, the second movable piece has an urging portion to urge against the second urged piece and a limiting portion limited and positioned by the stopper.

3. The hinge as claimed in claim 2, wherein the torsion spring abuts the connecting block, the positioning cam assembly is located between the torsion spring and the second support seat, the positioning cam assembly has a fixed cam fixed on the second support seat, a pivoting cam driven by the second pivot shaft to pivot, and the fixed cam and the pivoting cam correspond to each other.

4. The hinge as claimed in claim 2, wherein the first movable assembly further comprises a first support seat located symmetrically to the second support seat, a mounting hole is formed on the first support seat and correspond to the elongated hole for the first pivot shaft to insert and move therein, the first urged piece is fixedly mounted on an external surface of the first support seat, and the first movable piece is mounted on the other end of the first pivot shaft.

5. The hinge as claimed in claim 1, wherein the second movable assembly further comprises a second support seat, a torsion spring and a positioning cam assembly, the second movable piece has an urging portion and a limiting portion, an elongated hole is formed on the second support seat for the second pivot shaft to insert and move therein, the second urged piece is fixedly mounted on the second support seat, a stopper is mounted on the second support seat for blocking the limiting portion, the second urged piece is mounted on the second support seat and has a sunken space to receive the second movable piece and a sloped surface to urge against the urging portion, and the torsion spring abuts the connecting block.

6. The hinge as claimed in claim 5, wherein the second movable assembly further comprises a torsion spring and a positioning cam assembly, the torsion spring abuts the connecting block, the positioning cam assembly is located between the torsion spring and the second support seat, the positioning cam assembly has a fixed cam fixed on the second support seat, a pivoting cam driven by the second pivot shaft to pivot, and the fixed cam and the pivoting cam correspond to each other.

7. The hinge as claimed in claim 5, wherein the first movable assembly further comprises a first support seat located symmetrically to the second support seat, a mounting hole is formed on the first support seat to correspond to the elongated hole for the first pivot shaft to insert and move therein, the first urged piece is fixedly mounted on an external surface of the first support seat, and the first movable piece is mounted on the other end of the first pivot shaft.

8. The hinge as claimed in claim 1, wherein the second movable assembly further comprises a second support seat, a torsion spring and a pivoting cam, the second support seat has an elongated hole formed thereon for the second pivot shaft to insert and move therein and a stopper, one end of the torsion spring abuts the connecting block and the other end abuts the pivoting cam, one side of the second urged piece corresponds with the pivoting cam and a sunken space and a sloped surface are formed on an opposite surface of the second urged piece, the second movable piece has an urging portion moving along and urging against the sloped surface so as to drive the connecting block to move, and a limiting portion limited by the stopper.

9. The hinge as claimed in claim 8, wherein the first movable assembly further comprises a first support seat, a mounting hole is formed on the first support seat to correspond to the elongated hole for the first pivot shaft to insert and move therein, the first urged piece is fixedly mounted on an external surface of the first support seat, and the first movable piece is mounted on the other end of the first pivot shaft.

10. An electronic device having a hinge and comprising:
a base;
a top lid having a display screen;
a hinge connected with the base and the top lid; and
a cover mounted on the base to enclose the hinge;
wherein the hinge comprises
a first pivoting module connected with the base and comprising:
a connecting block having a bore;
a first pivot shaft and a second pivot shaft mounted on two opposite surfaces of the connecting block;
a first movable assembly mounted on the first pivot shaft and having a first urged piece and a first movable piece tracing and urging against the first urged piece so as to radially move the first pivot shaft; and
a second movable assembly mounted on the second pivot shaft to operate in coordination with the first movable assembly and having a second urged piece and a second movable piece tracing and urging against the second urged piece so as to radially move the second pivot shaft; and
a second pivoting module pivotally mounted on the connecting block and connected with the top lid.
